(19) United States
(12) Patent Application Publication
(10) Pub. No.: US 2009/0071150 A1
(43) Pub. Date: Mar. 19, 2009

(54) Mixing Unit for LP-EGR Condensate Into the Compressor

(75) Inventors: Volker Joergl, Ortonville, MI (US); Timm Kiener, Lake Orion, MI (US); Olaf Weber, Bloomfield hills, MI (US)

Correspondence Address: WARN, HOFFMANN, MILLER & LALONE, .P.C, PO BOX 70098, ROCHESTER HILLS, MI, 48307, US

(73) Assignee: BORGWARNER INC., Auburn Hills, MI (US)

(21) Appl. No.: 12/087,277

(22) PCT Filed: Jan. 26, 2007
(86) PCT No.: PCT/US2007/002140

§ 371 Date: Jun. 30, 2008

Related U.S. Application Data
(60) Provisional application No. 60/762,664, filed on Jan. 27, 2006.

(51) Int. Cl. F02M 25/07; F02B 33/34

(52) U.S. Cl. 60/605.2

(57) ABSTRACT

The present invention is a an exhaust gas return system (10) for reintroducing condensate generated in exhaust gas from an engine (14) into a compressor (36) of a turbocharger (18), having a turbocharger unit (18) having a turbine (20) and a compressor (36), and a compressor wheel (42) located inside the compressor (36). The present invention also includes a mixing pipe (52) located inside an intake tube (44) for receiving exhaust gas with droplets (54) from an EGR-tube (46), wherein the EGR-tube (46) delivers the exhaust gas with droplets (54) to the mixing pipe (52), mixing the air (41) and the exhaust gas with droplets (54) forming a mixture (64) containing droplets (50), and introducing the mixture (64) and the droplets (50) onto the compressor wheel (42) in an area of low circumferential speed, preventing damage to the compressor wheel (42).

### CROSS-REFERENCE TO RELATED APPLICATIONS

This application claims the benefit of U.S. Provisional Application No. 60/762,664, filed Jan. 27, 2006.

### TECHNICAL FIELD

The present invention relates to an Exhaust Gas Return (EGR) valve assembly used with a turbocharger unit. More particularly, the reintroduction of EGR condensate into the intake pipe in front of the compressor wheel of the turbocharger unit.

### BACKGROUND OF THE INVENTION

Turbocharging units are a commonly used way to increase the power of an engine, both with conventional internal combustion engines, and Diesel engines. Turbochargers are comprised of a turbine, and a compressor. The turbine receives exhaust gas from the exhaust manifold of the engine, and the turbine wheel located inside the turbine rotates, powering a compressor wheel inside the compressor. The compressor forces high-pressure air into the intake manifold of the engine, increasing power output.

Due to increased environmental concerns, an emphasis has been placed on reducing the emissions of both internal combustion engines and Diesel engines. One method that has been used to reduce emissions has been to reintroduce exhaust gas into the intake manifold of the engine, reducing the amount of exhaust gas released into the atmosphere. This is commonly achieved through the use of an exhaust gas return (EGR) device.

Current and future emission requirements for Diesel Engines in Europe, the U.S., and most foreign markets will require engine concepts capable of delivering high EGR flow-rates at very low vehicle loads/speeds. One way of providing these EGR flow-rates is by using low pressure EGR. However, exhaust gas may contain a high amount of moisture, dependent on the humidity of the air and the fuel quantity burned in the combustion chamber of the engine. The path the exhaust gas flows through, also called the EGR path, is comprised of the turbocharger, a particulate filter, an exhaust pipe, an EGR path, a low-pressure EGR path, and a low pressure EGR cooler.

While the moisture passing through the EGR path can occur, at certain driving conditions such as cold ambient temperature or low engine loads, condensation occurs and moisture droplets form. These droplets of different aerodynamic radii pass through the EGR path, the low-pressure EGR path, the low pressure EGR cooler, and into the intake pipe in front of the rotating compressor wheel, also called the mixing area.

One major problem with the droplets coming into contact with the compressor wheel is droplet erosion on the compressor wheel. One way to keep droplets from hitting the compressor wheel in a critical area is to have the droplets permanently removed from the mass flow going into the compressor wheel under all driving conditions. It is very difficult to permanently remove the droplets out of the system in an area downstream of the compressor because of the negative pressure drop to atmosphere (pumping would be necessary). Also, humidity in the intake air is a positively influencing parameter for in-cylinder NOx reduction.

Another way to keep droplets from hitting the compressor wheel area is to temporarily separate the condensate from the exhaust gas flow, and then re-introduce the droplets into the exhaust gas in an area to avoid corrosion of the blades on the compressor wheel. This is difficult because the dispersion of droplets can cause damage to the compressor wheel blades.

### SUMMARY OF THE INVENTION

The present invention is a an EGR system for re-introducing condensate generated in exhaust gas from an engine into a compressor of a turbocharger, having a turbocharger unit having a turbine and a compressor, a low pressure EGR loop located downstream from the turbine and upstream from the compressor, and a compressor wheel located inside the compressor. There is also an intake tube connected to the compressor having an opening to atmosphere for introducing air into the compressor, an EGR-tube connected to the low pressure EGR loop on a first end, and connected to the intake tube on a second end. The present invention also includes a mixing pipe located inside the intake tube for receiving exhaust gas with droplets from the EGR-tube, wherein the EGR-tube delivers the exhaust gas with droplets from the low pressure EGR loop to the mixing pipe, mixing the air and the exhaust gas with droplets forming a mixture containing droplets, and introducing the mixture and the droplets onto the compressor wheel in an area of low circumferential speed, preventing damage to the compressor wheel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a is a diagram of an engine having a turbocharging unit, according the present invention;

FIG. 2 is a side view of the assembly according to a first embodiment of the present invention; and

FIG. 3 is a side view of the assembly according to an alternate embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

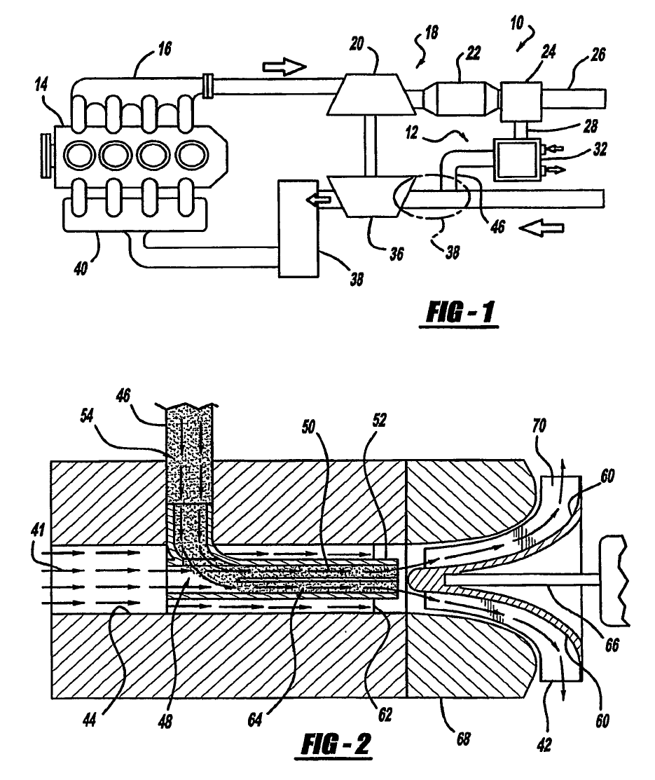

FIG. 1 is a schematic view of a conventional diesel engine breathing system incorporating the present invention. As will be described herein, a system 10 has a low pressure EGR loop 12. Exhaust gas is generated by an engine 14 and exits through an exhaust manifold 16. The exhaust gas from the exhaust manifold 16 passes through the turbine 20 and is then introduced to a diesel particulate filter (DPF) 22 where the exhaust gas is cleaned of soot material. After going through the DPF 22, the exhaust gas will then flow to an EGR valve module 24 where the exhaust gas is split between either flowing into an exhaust pipe 26 where it leaves the vehicle, or into an EGR path 28 that is part of a low-pressure EGR loop 12 where the exhaust gas will be reintroduced through the engine 14 for combustion.

The exhaust gas that flows into the EGR path 28 will pass through a low pressure EGR cooler 32 that cools the temperature of the exhaust gas prior to re-combustion. The exhaust gas exits the low pressure EGR cooler 32, passes through a first passageway, or EGR tube 46, mixes with air in the mixing area 34 and is introduced to a compressor 36 which pressurizes both exhaust gas and outside air for introduction to the engine 14. The mixed intake gas is then passed through a charge air cooler 38 into the intake manifold 40 of the engine 14.

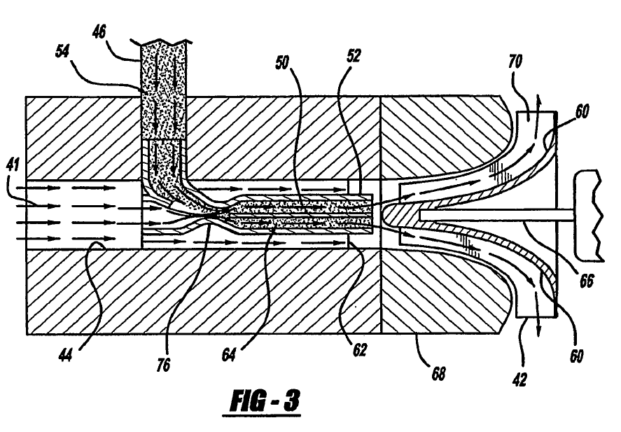

A first embodiment of the present invention is shown in FIG. 2. Intake air 41 flows through a second passageway, or an intake tube 44, toward the compressor wheel 42; the intake tube 44 is connected to the compressor wheel housing 68. The compressor wheel 42 is located in the compressor housing 68 and rotates on a compressor wheel shaft 66, which forms a compressor wheel axis. Connected to the intake tube 44 is EGR-tube 46. Also connected to the EGR-tube 46 and located inside the intake tube 44 is a third passageway, or mixing pipe 52. The mixing pipe 52 has a smaller diameter than the intake tube 44, and is located inside the intake tube 44 such that part of the intake air 41 flows through the mixing pipe 52, and the remaining intake air 41 flows around the mixing pipe 52. The mixing pipe 52 is connected to the EGR-tube 46 in a manner to cause all of the exhaust gas with droplets, generally shown at 54, to flow directly into the mixing pipe 52.

Exhaust gas with condensate, or exhaust gas with droplets 54, released from the engine 14 flow through the low-pressure EGR loop 12 (shown in FIG. 1) and exits the EGR-tube 46. The exhaust gas with droplets 54 contains droplets or liquid condensate 50 which will be mixed with the intake air 41 before reaching the compressor wheel 42. The exhaust gas with droplets 54 flows through and exits the EGR-tube 46 into the mixing pipe 52. The exhaust gas with droplets 54 is brought to the middle of the intake tube 44 into the mixing pipe 52 of a diameter optimized for the maximum amount of EGR to be introduced. There, the exhaust gas with droplets 54 is mixed with part of the intake air 41 that flows into the mixing pipe 52. The intake air 41 and the exhaust gas with droplets 54 mix together to form an exhaust gas and air mixture, generally shown at 64, at a mixing point, generally shown at 48. The mixture 64 still contains droplets 50 when in the mixing pipe 52.

The rest of the intake air 41 travels around the mixing pipe 52 onto the compressor wheel 42. The mixing pipe 52 is positioned close enough to the compressor wheel 42, that the mixture 64 and droplets 50 stream onto the compressor wheel 42 near the area of the compressor wheel 42 aligned with the mixing pipe 52, where the circumferential speed of the compressor wheel 42 is small enough such that any droplets 50 existing in the mixture 64 cannot harm the compressor wheel 42, or the droplets 50 are transformed into a liquid film 60 which cannot harm the compressor wheel 42. The exact geometrical form of the mixing pipe 52 close to the compressor wheel 42 and the matching form of the compressor wheel 42 center area is not the subject of this patent, just the principle of introducing low pressure EGR in this manner.

The mixing pipe 52 is supported by a connection to either the compressor housing 68 or the intake tube 44, so the mixing tube 52 is perfectly aligned with the compressor wheel shaft 66. The support, shown as guiding fins 62, must be designed in a way to influence the flow in front of the compressor wheel 42 in the desired way.

Another embodiment of the present invention is shown in FIG. 3, and is described in the technical paper “EGR System in a Turbocharger and Intercooled Heavy Duty Diesel Engine—Expansion of EGR area with Venturi EGR System” by Hitoshi Yokomura, Susumu Kohketsu, Koji Mori, Engine Research Department, research Dev. Office MFTBC.

The system shown in FIG. 3 is similar to the system shown in FIG. 2, except that a venturi 76 is incorporated into the mixing pipe 52. The venturi 76 is comprised of a reduced diameter area of the mixing pipe 52. Because of the venturi 76, the exhaust gas with droplets 54 is now introduced at the smallest cross-sectional area of the mixing pipe 52. Due to the lower pressure in the smallest cross-sectional area of the mixing pipe 52, the pressure drop through the EGR tube 46 is increased and EGR introduction is therefore enhanced. The venturi 76 is designed in such a way that pressure drop of the intake air 41 flowing through the venturi 76 is minimized.

The introduction of a venturi 76 in front of the compressor wheel 42 to enhance low pressure EGR delivery by increasing the pressure drop through the LP-EGR loop 12 is not limited to incorporating the venturi 76 into the mixing pipe 52. The venturi 76 may also be incorporated into the intake tube 44 itself. Incorporating the venturi 76 into the intake tube 44 will cause the entire amount of intake air 41 to pass through the venturi 76. However, it should be noted that incorporating the use of a venturi 76 into the intake pipe 44 will necessitate the use of a larger venturi 76.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An exhaust gas return arrangement for re-introducing condensate generated in exhaust gas from an engine into a compressor of a turbocharger, comprising:
a compressor wheel;
a first passageway for delivering exhaust gas to said compressor wheel;
a second passageway connected to said compressor for introducing air to said compressor from atmosphere; and
a third passageway located inside said second passageway for receiving exhaust gas with droplets from said first passageway; wherein said first passageway delivers said exhaust gas with droplets to said third passageway, mixing said air and said exhaust gas with droplets forming a mixture containing droplets, and introducing said mixture and said droplets onto said compressor wheel in an area of low circumferential speed, preventing damage to said compressor wheel.

2. The exhaust gas return arrangement of claim 1, wherein said third passageway has a smaller diameter than said second passageway.

3. The exhaust gas return arrangement of claim 1, wherein said third passageway is located in proximity to said compressor wheel axis such that said mixture and said droplets stream onto said compressor wheel.

4. The exhaust gas return arrangement of claim 1, wherein said third passageway has a constant diameter, and said second passageway has a constant diameter.

5. The exhaust gas return arrangement of claim 1, wherein said third passageway has a venturi located in proximity to said first passageway.

6. The exhaust gas return arrangement of claim 5, wherein said venturi causes a pressure drop through said first passageway, enhancing the introduction of said exhaust gas with droplets into said third passageway.

7. The exhaust gas return arrangement of claim 1, wherein said second passageway has a venturi located in proximity to said first passageway and said air and said exhaust gas with droplets is introduced in proximity to said venturi.

8. The exhaust gas return arrangement of claim 7, wherein said venturi causes a pressure drop through said first passageway, enhancing the introduction of said exhaust gas with droplets into said third passageway.

9. An arrangement for reintroducing exhaust gas having moisture into the compressor of a turbocharger after being discharged from an engine, comprising:
a compressor wheel, having a compressor wheel axis that said compressor wheel rotates about;
an exhaust gas return tube for delivering exhaust gas to said compressor wheel;
an intake tube operably connected to said compressor wheel for introducing air from atmosphere to said compressor wheel, and operably connected to said exhaust gas return tube; and
a mixing pipe located in proximity to said compressor wheel axis, wherein said exhaust gas return tube introduces exhaust gas with droplets discharged from said engine into said mixing pipe where said exhaust gas with droplets mixes with said air in said mixing pipe forming a mixture, and streams onto said compressor wheel in proximity to said compressor wheel axis.

10. The arrangement for reintroducing exhaust gas of claim 9, wherein said mixing pipe is located inside said intake tube such that at least a portion of said air flows around said mixing pipe, and a portion of said air flows through said mixing pipe mixing with said exhaust gas with droplets, forming said mixture.

11. The arrangement for reintroducing exhaust gas of claim 10, wherein said intake tube has a constant diameter, and said mixing pipe includes a venturi, said venturi comprised of a decreased diameter area of said mixing pipe.

12. The arrangement of claim 9 wherein said intake tube includes a venturi, wherein said venturi causes a pressure drop through said exhaust gas return tube, enhancing the introduction of said exhaust gas with droplets into said mixing pipe.

13. An arrangement for reintroducing exhaust with droplets discharged from an engine into air flowing into a compressor of a turbocharger unit, comprising:
a turbocharger having a turbine and a compressor;
a compressor wheel located inside said compressor rotatable about a compressor wheel axis;
an intake tube for receiving air from atmosphere, and delivering said air to said compressor wheel;
an exhaust gas return tube for receiving exhaust gases from said turbine, and connected to said intake tube; and
a mixing pipe located inside said intake tube, connected to said exhaust gas return tube, wherein when said exhaust gas with droplets emitted from said engine is transported through said exhaust gas return tube, and into said mixing pipe, said exhaust gas with droplets is mixed with at least a portion of said air, distributing said droplets onto said compressor wheel in proximity to said compressor wheel axis.

14. The arrangement of claim 13, wherein all of said exhaust gas with droplets is delivered from said exhaust gas return tube to said mixing pipe.

15. The arrangement of claim 13, wherein said mixing tube features a constant diameter, and said intake tube features a constant diameter.

16. The arrangement of claim 13, wherein said intake tube further comprises a constant diameter, and said mixing pipe further comprises a venturi comprised of a reduced diameter area of said mixing pipe.
